(19) United States
(12) Patent Application Publication
(10) Pub. No.: US 2010/0078906 A1
(43) Pub. Date: Apr. 1, 2010

(54) SUSPENSION SYSTEM

(76) Inventors: Allen Clover Pilgrim, Preston (AU); Michael Glenn Pilgrim, Preston (AU)

Correspondence Address: MEYERTONS, HOOD, KIVLIN, KOWERT & GOETZEL, P.C., P.O. BOX 398, AUSTIN, TX, 78767-0398, US

(21) Appl. No.: 12/570,877

(22) Filed: Sep. 30, 2009

(30) Foreign Application Priority Data
Oct. 1, 2008 (AU) 2008905121

(51) Int. Cl. B62B 7/04

(52) U.S. Cl. 280/47.22; 280/47.17

(57) ABSTRACT

A suspension system for a wheeled conveyance includes a swing arm coupled to be pivotally mounted to a part of wheeled conveyance. The swing arm has one end thereof coupled to one end of an extensible biasing means and the other end of extensible biasing means configured to be coupled to a further part of wheeled conveyance. The other side of swing arm has a wheel mount for a wheel of wheeled conveyance. The swing arm having its pivot point between said one end and said other side of said swing arm.

### BACKGROUND OF THE INVENTION

1. Field of the Invention

The present invention relates to a suspension system and relates particularly, though not exclusively, to a suspension system for a golf buggy.

2. Description of the Relevant Art

Spring suspension systems for golf buggies are known as shown in Australian Patent Application No, 2003271432. In this application a hinged scissor link is used with compression spring being compressed when travelling over undulations. The spring can be replaced by a shock absorber piston arrangement but they all suffer the same problem of “bottoming out” when there is no further compression available. There is also an unacceptable friction generated if shock absorbers replace the compression spring.

### SUMMARY OF THE INVENTION

Embodiments described herein are directed to a suspension system which overcomes these deficiencies.

The embodiments described herein are further directed to a suspension system which is simple to fit and maintains correct buggy geometry.

A suspension system for a wheeled conveyance includes a swing arm configured to be pivotally mounted to a part of said wheeled conveyance, said swing arm having one end thereof coupled to one end of an extensible biasing means and the other end of said extensible biasing means configured to be coupled to a further part of said wheeled conveyance, the other side of said swing aim having a wheel mount for a wheel of said wheeled conveyance and said swing arm having its pivot point between said one end and said other side of said swing arm.

In some embodiments, said further part of said wheeled conveyance is above said one end of said swing arm. It is preferred that said extensible biasing means is a spring, typically a coil spring.

In a practical embodiment said wheel mount is a sleeve for an axle of said wheel.

### BRIEF DESCRIPTION OF THE DRAWINGS

The structure and functional features of referred embodiments of the present invention will become more apparent from the following detailed description when taken in conjunction with the accompanying drawings, in which:

FIG. 1 is a front perspective view of a first embodiment of a golf buggy or cart incorporating a suspension system;

FIG. 2 is a rear perspective view of the golf buggy or cart shown in FIG. 1;

FIG. 3 is a rear perspective view similar to FIG. 2 but showing the attachment of the wheels to the frame of the golf buggy or cart;

FIG. 4 is a similar view to that of FIG. 3 viewed from above;

FIG. 5 is a side view of the golf buggy or cart of FIG. 1 with a golf bag attached;

FIG. 6a is an enlarged view of the suspension system with the spring in a first position;

FIG. 6b is a similar view to that of FIG. 6a with the spring in a second position;

FIG. 7 is a similar view to that of FIG. 1 showing the golf buggy or cart moving over a non-level surface;

FIG. 8a is a rear perspective view of a golf buggy or cart having a suspension system;

FIG. 8b is a front perspective view of FIG. 8a;

FIG. 9 is a similar view to that of FIG. 8b at a higher viewing angle;

FIG. 10a is a view from arrow 10a on FIG. 9;

FIG. 10b is a vertical cross-sectional view through the braking mechanism of the suspension system of FIG. 10a;

FIG. 10c is view in the direction of arrow 10c in FIG. 10b but having the braking mechanism shown in the braked position;

FIG. 11a is a view in the direction of arrow 11a in FIG. 9; and

FIG. 11b is a similar view to thin of FIG. 11a showing movement over an undulating surface.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF THE PREFERRED EMBODIMENTS

In order to avoid duplication of description, identical reference numerals will be shown, where applicable, throughout the illustrated embodiments to indicate similar integers.

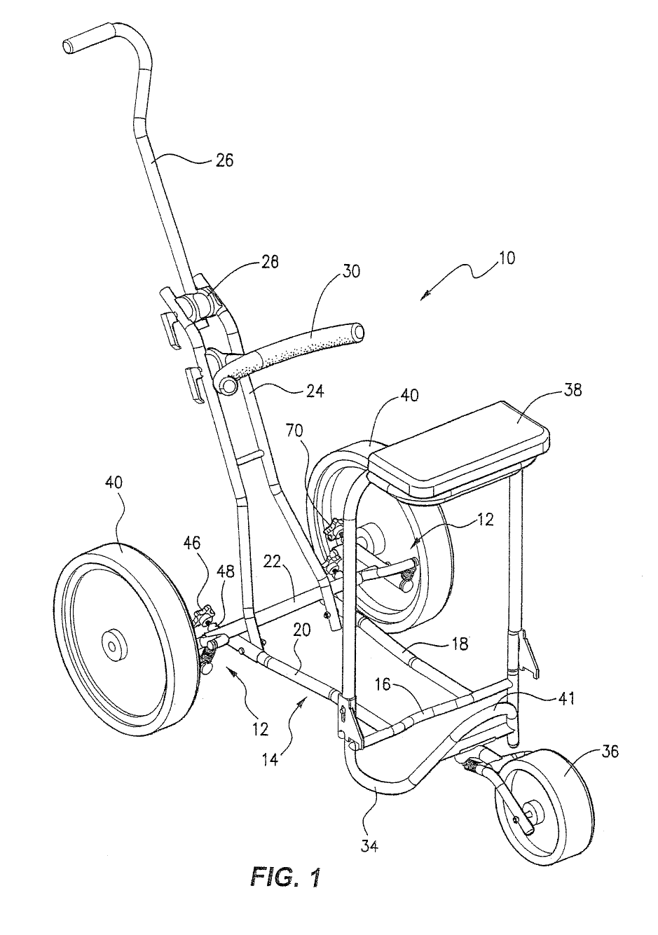

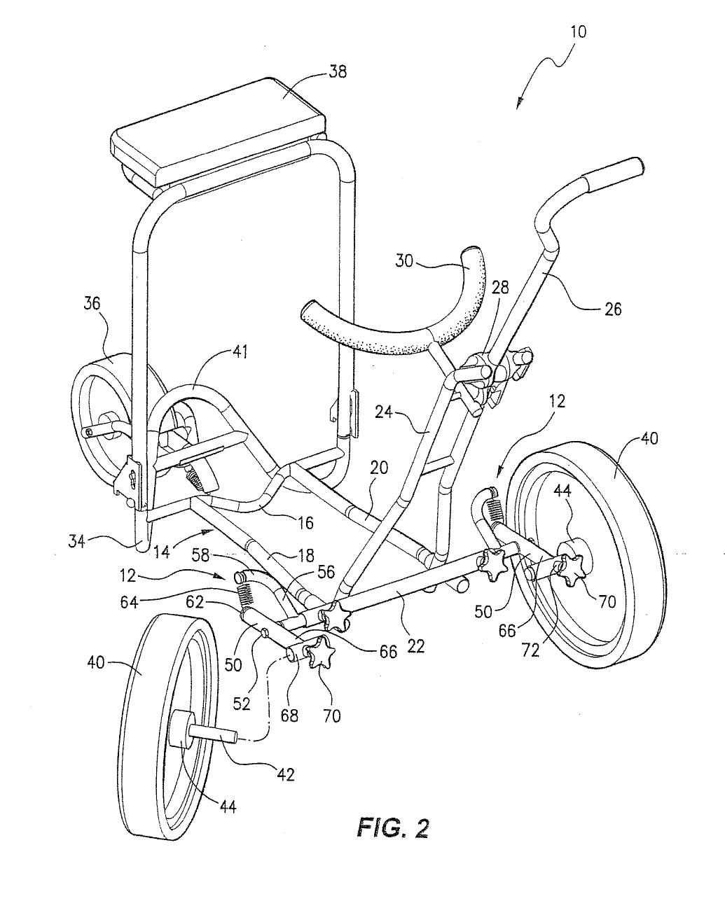

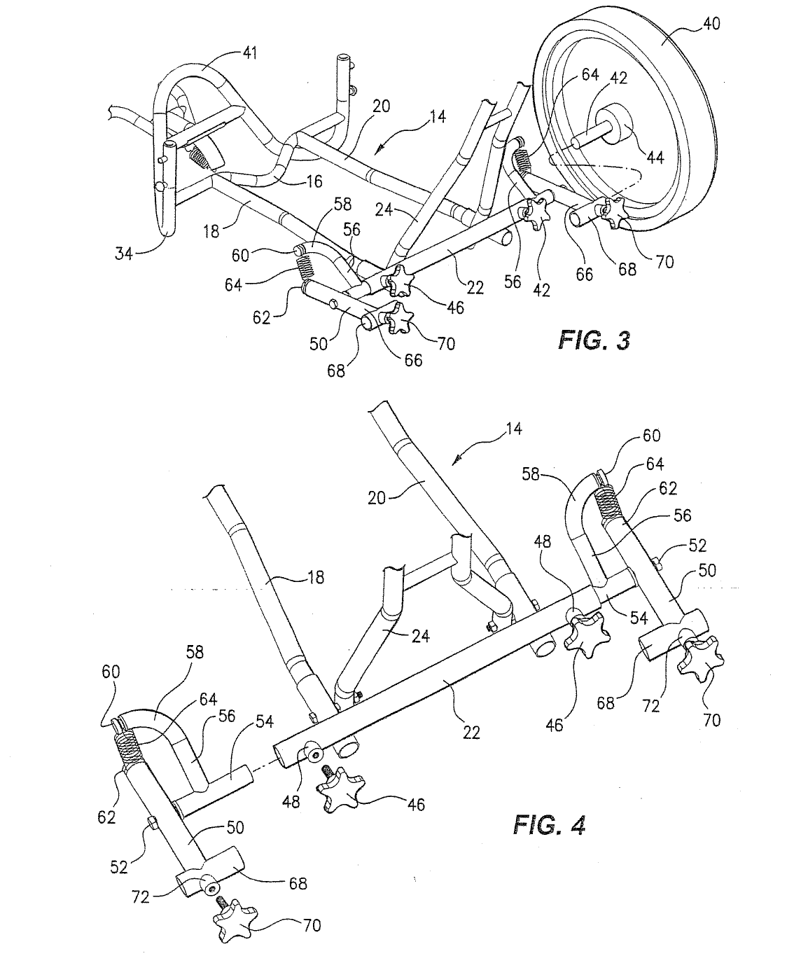

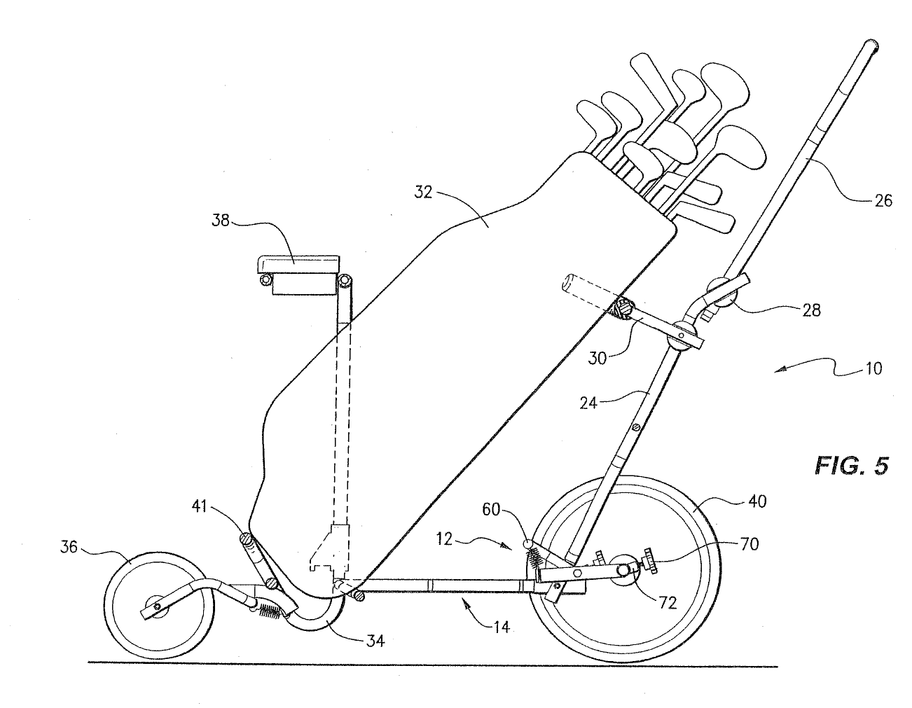

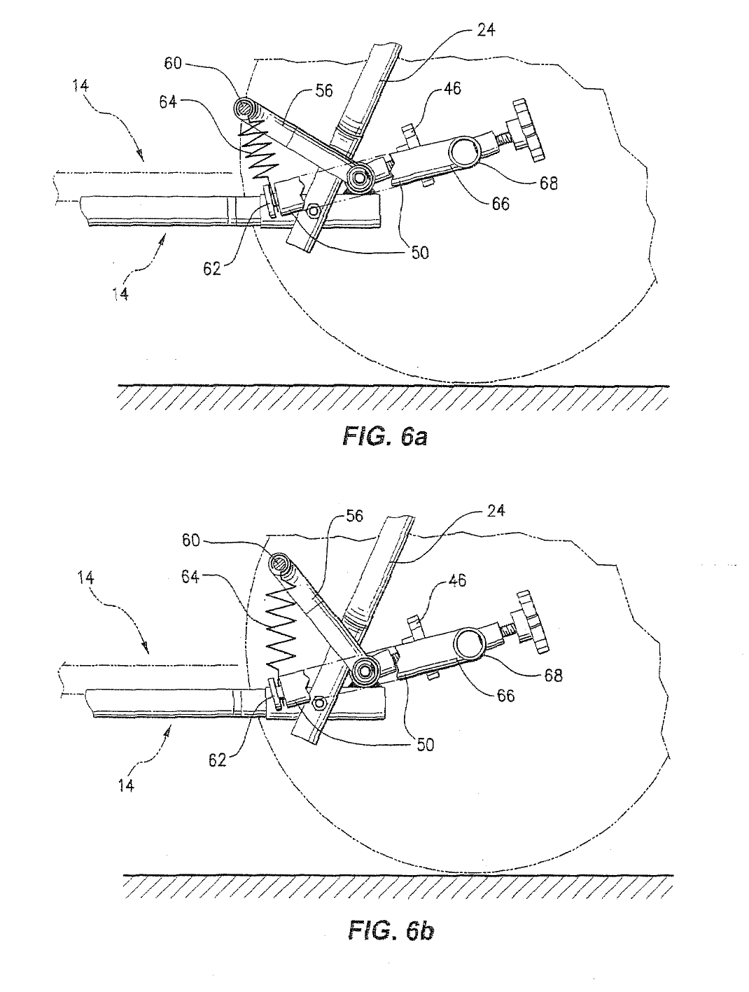

In the drawings a first embodiment is shown in FIGS. 1 to 7 in which there is shown a hand pulled golf buggy or cart 10. The golf buggy 10, except for the rear suspension 12, is readily available from a sports store. Typically, buggy 10 will include a horizontal base frame 14 having a front frame element 16, two side frame elements 18, 20 and a rear sleeve 22 for retaining the attachment of the rear suspension 14 thereto. An angled U-shaped frame member 24 is pivotally attached to the side frame elements 18, 20 to enable the golf buggy 10 to be folded away. A handle 26 is also pivotally attached to frame member 24 by a ratchet device 28 to allow the handle to be folded away for storage and allows the handle to be angularly adjusted to suit the goiter. A U-shaped support 30 is also pivotally attached to frame member 24 to cradle a golf bag 32. A stand 34 allows contact with the ground if a sprung third wheel 36 bottoms out on the ground when a golfer sits on the seat 38. A bag rest 41 prevents the golf bag 32 from dragging across the ground when moving the buggy 10. The golf buggy or cart 10 completes the description of the typical golf buggy or cart.

One embodiment is directed to a suspension for the rear wheels 40 of a golf buggy or cart.

The wheels 40 have a large diameter and a wide tread to prevent damage to the grass of a golf course. Each wheel has a stub axle 42 which is rotatable in the hub 44 of wheel 40. In the prior art there would be no suspension and the stub axles 42 would be inserted into the open ends of rear sleeve 22 and locked into position through respective locking screws 46 which enter sleeve 22 through threaded bosses 48. The wheels 40 may be attached to rear sleeve 22 through a suspension system to be now described.

The suspension includes a swing arm 50 which is pivotally mounted at 52 to an axle 54. Axle 54 is configured to slide inside rear sleeve 22 and be locked into position by locking screws 46. Axle 54 has an arm member 56 which is forwardly mounted thereon in this embodiment. It is possible to reverse this position if required. Ann member 56 has a bent arm 58 whose free end is located outwardly of the buggy 10 and is located above swing arm 50. The free end 60 of arm 58 is coupled to one end 62 of swing arm 50 by a spring 64. Spring 64 is typically a coil spring which is tensioned when stretched. At the other end 66 of swing arm 50 is a sleeve 68 mounted at right angles to swing arm 50. Sleeve 68 has locking screw 70 which enters sleeve 68 through a threaded boss 72. Wheels 40 can be secured to buggy 10 through axle 42 being inserted into sleeve 68 and being locked into position by locking screw 70.

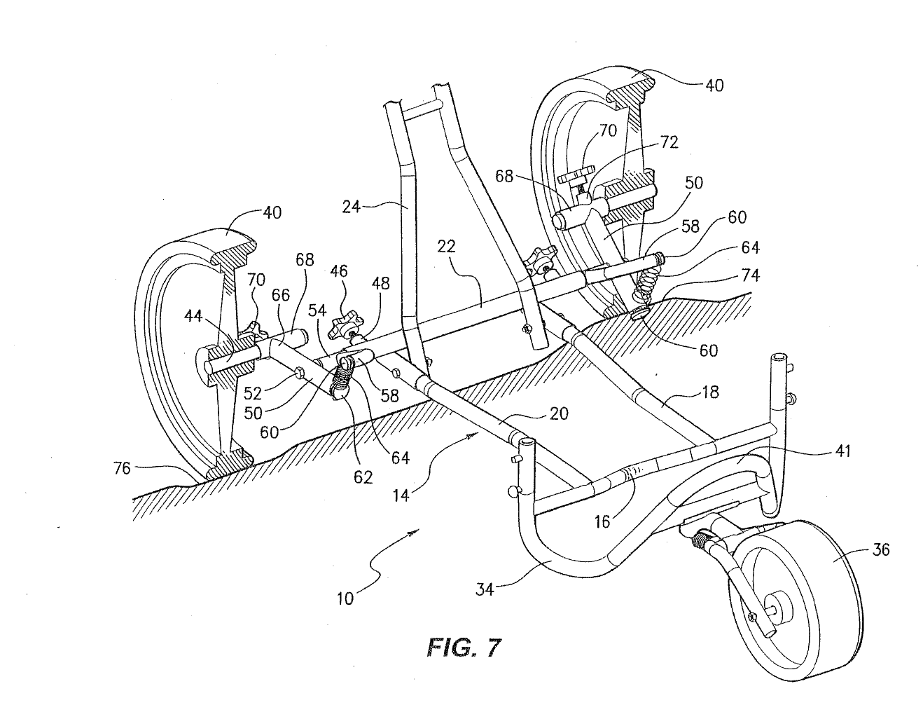

FIGS. 6a and 6b illustrate how the tension can be adjusted for the suspension. FIG. 6a shows the position of base frame 14 under load i.e. when carrying golf bag 32, whereas the broken lines indicate the unloaded position without golf bag 32. FIG. 6b shows a similar view to that of FIG. 6a but the position of arm member 56 has been rotated relative to swing arm 50 to extend spring 64. The resulting tension will allow the same ground clearance to be retained as in FIG. 6a but a heavier load can be carried by the buggy through the additional spring tension. The softness of the spring 64 can be predetermined by the type of spring used and the relative rotation as described of swing arm 50 as described above.

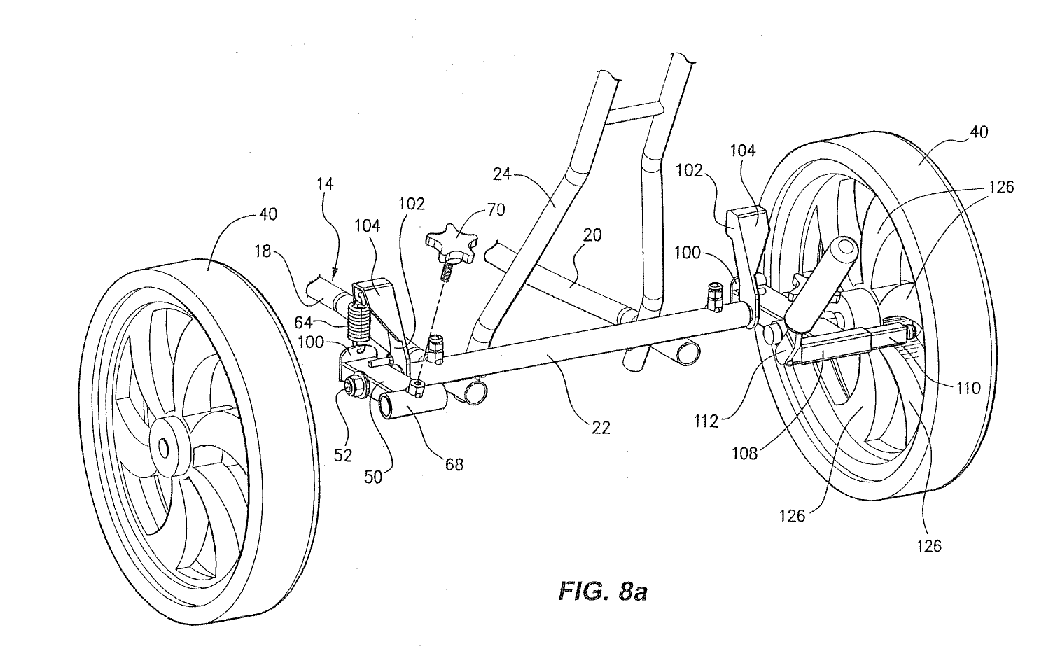

The operation of this embodiment is clearly illustrated in FIG. 7 where buggy 10 is shown to be travelling over undulating ground. The golf bag 32 has been removed to show the wheels 40 and the action of the suspension. FIG. 7 shows a mound 74 over which wheel 40 must move. Wheel 40 will ride over mound 74 and cause swing arm 50 to rise up or rotate about pivot 52. The rotation of swing arm 50 will have the opposite effect on end 62 which will rotate downwardly under the tension of spring 64. There will be smooth transition with the buggy 10 maintaining its position relative to the ground. The other wheel 40 is shown entering a depression 76 in the ground and the reverse rotation of swing arm 50 will occur. The suspension system will provide a smooth ride over any undulations or depressions.

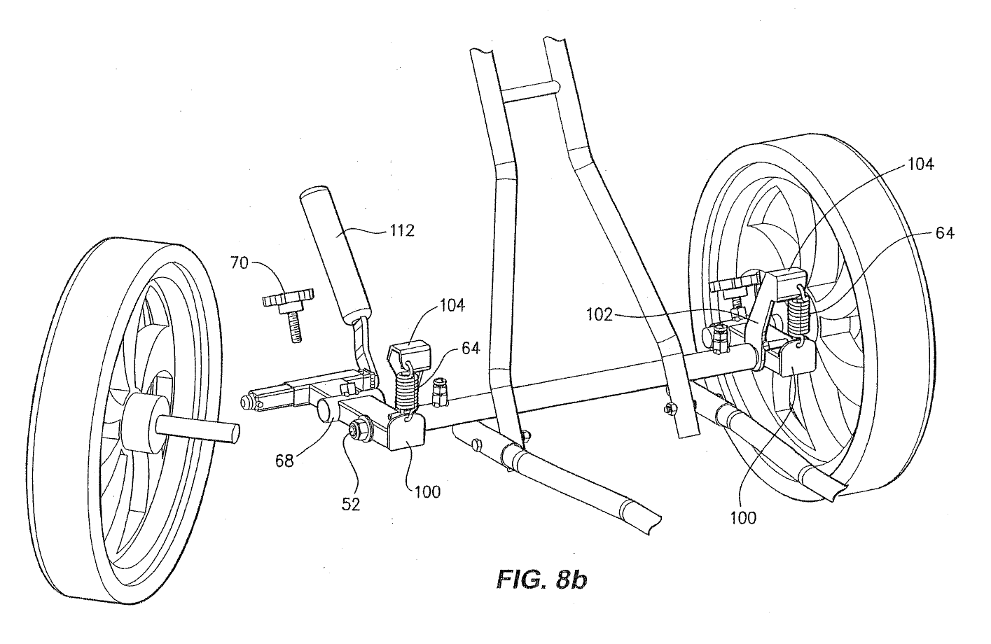

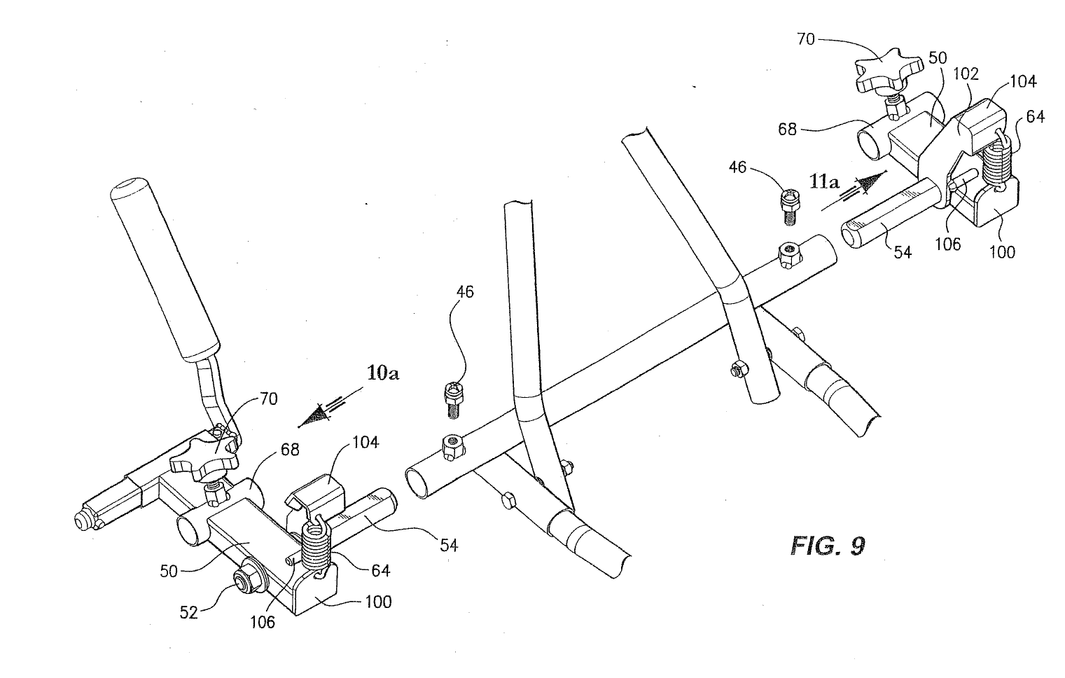

In FIGS. 8 to 11 a second embodiment is shown which is operationally similar to the embodiment described with reference to FIGS. 1 to 7. The same reference numerals have been used for similar integers to avoid duplication and repetition of description. Reference should be made to the previous embodiment when previously referenced integers are not described in this embodiment. This embodiment is suited to retro fitting an existing golf buggy with the suspension system. In this embodiment the circular tubing except for sleeves 68 has been replaced by square or rectangular tubing. Swing arm 50 has rectangular tubing and has an end tab 100 to which one end of spring 64 is attached. Arm member 56 and bent arm 58 has been replaced by a shaped angle arm member 102 which has a side arm 104 which acts like a hooded end member. The other end of spring 64 is attached to side arm 104. A stop member 106 projects from shaped arm member 102 which limits the downward movement of wheel 40. This embodiment has the spring 64 basically vertically disposed whereas FIGS. 1 to 7 have spring 64 angularly disposed. The angular disposition of spring 64 in either embodiment can be varied to suit requirements.

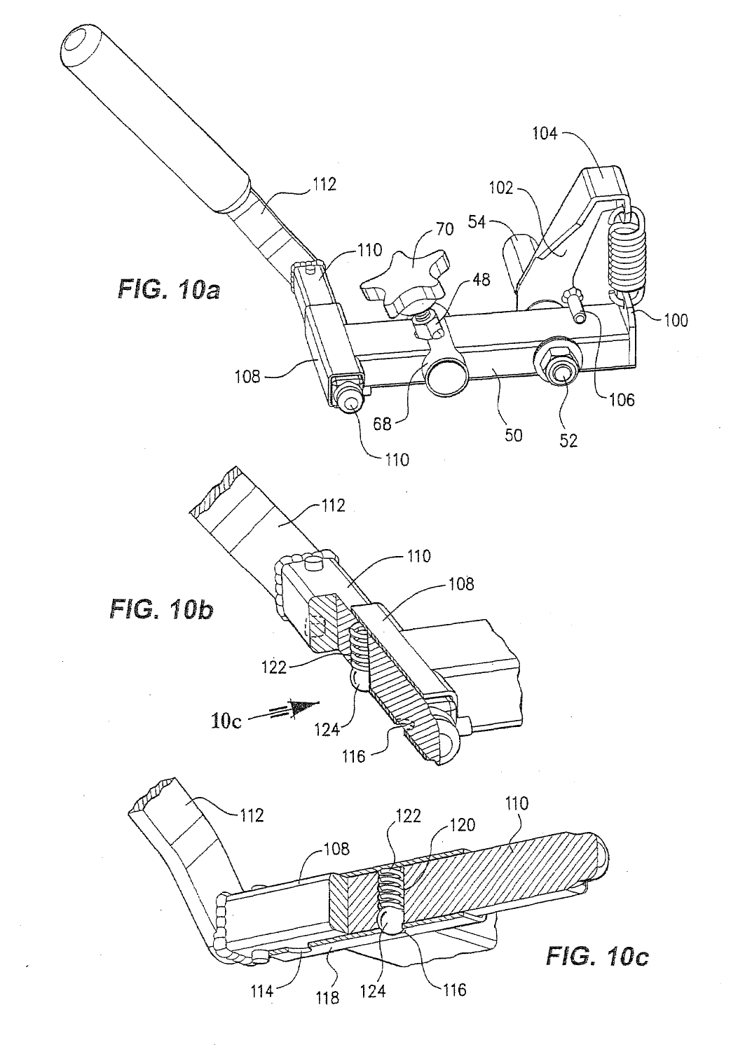

A further version of the suspension system is shown in FIGS. 8 to 11 but specifically in FIGS. 10a, 10b and 10c. This version has the swing arm 50 extending beyond sleeve 68 and terminated by a square sleeve 108. This will allow sleeve 68 to be on the opposite side of pivot 52 but not at the end of swing arm 50. A rod 110 is slidably located within sleeve 108 and can be locked in a first position shown in FIGS. 10a and 10b and a second position shown in FIG. 10c. Rod 110 is a loose fit within sleeve 108. A handle 112 is secured to the end of rod 110 to allow the rod 110 to be moved between the first and second positions. A pair of apertures 114, 116 is located in the wall 118 of sleeve 108. Rod 110 has a bore 120 into which is located a spring 122 which abuts a ball 124 at one end and the inner wall of sleeve 108 at the other end. The apertures 114, 16 have a diameter less than the diameter of ball 124 which allows ball 124 to protrude therethrough without escaping from rod 110. By rotating handle 112 and simultaneously pushing or pulling handle 112 ball 124 will be forced inwards and rod 110 can be moved between the first and second positions. When handle 112 is returned to its non rotated position ball 124 will sufficiently protrude through aperture 114 or 116 to prevent rod 110 from moving. Wheel 40 may have spokes 126. When rod 110 is in the second position shown in FIGS. 8a and 10c then wheel 40 will not be able to rotate because rod 110 will engage with the sides of spokes 126. This will prevent the buggy from moving or rolling away on inclined ground.

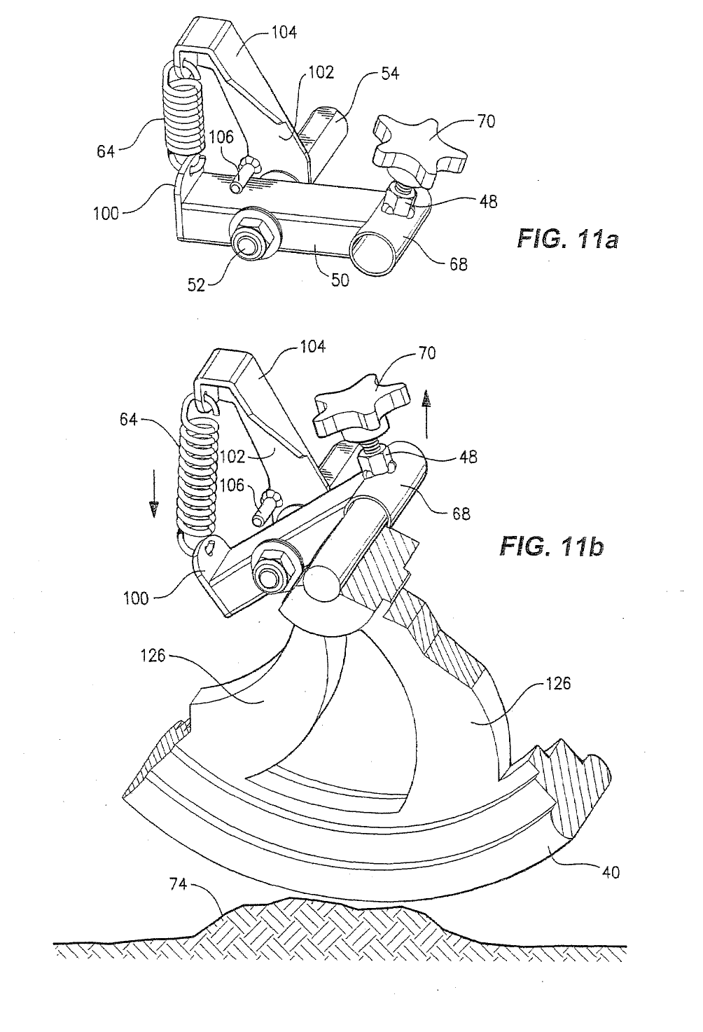

The operation of the suspension system shown in FIGS. 8 to 11 is identical to that described in FIGS. 1 to 7 with FIG. 11b showing the movement of swing arm 50 when moving over mound 74.

Although the preferred embodiments provide a useful solution the invention is not limited to the embodiments disclosed. The shape and construction of the suspension system can be varied to suit requirements. The use of an extensible spring 64 and swing arm 50 provides a smooth suspension system.

The invention will be understood to embrace many further modifications as will be readily apparent to persons skilled in the art and which will be deemed to reside within the broad scope and ambit of the invention, there having been set forth herein only the broad nature of the invention and certain specific embodiments by way of example.

What is claimed is:

1. A suspension system for a wheeled conveyance, said suspension system comprising a swing arm configured to be pivotally mounted to a part of said wheeled conveyance, said swing arm having one end thereof coupled to one end of an extensible biasing means and the other end of said extensible biasing means configured to be coupled to a further part of said wheeled conveyance, the other side of said swing arm having a wheel mount for a wheel of said wheeled conveyance and said swing arm having its pivot point between said one end and said other side of said swing arm.

2. The suspension system of claim 1, wherein said further part of said wheeled conveyance is above said one end of said swing arm.

3. The suspension system of claim 1, wherein said extensible biasing means is a spring.

4. The suspension system of claim 3, wherein said spring is a coil spring.

5. The suspension system of claim 1, wherein said wheel mount is a sleeve for an axle of said wheel.

6. The suspension system of claim 1, wherein said further part of said wheeled conveyance includes an arm member.

7. The suspension system of claim 5, wherein said sleeve is at the other end of said swing arm.

8. The suspension system of claim 5, wherein said sleeve is between said pivot point and the other end of said swing arm.

9. The suspension system of claim 8, wherein a further sleeve is provided at the other end of said swing arm, said further sleeve configured to receive a lock means which can interfere with said wheel to limit rotation of said wheel.

10. The suspension system of claim 9, wherein said lock means has a first position within said further sleeve where said lock means interferes with said wheel to rotation of said wheel and a second position where the lock means is free of said wheel to allow rotation thereof.

11. The suspension system of claim 1, wherein a stop member is provided on said further part of said wheeled conveyance to limit downward movement of said wheel.

12. A golf buggy to allow a golf bag to be pushed or pulled by a golfer, said golf buggy comprising a plurality of wheels and one of said wheels having a suspension system said suspension system including a swing configured to be pivotally mounted to a part of said wheeled conveyance, said swing arm having one end thereof coupled to one end of an extensible biasing means and the other end of said extensible biasing means configured to be coupled to a further part of said wheeled conveyance, the other side of said swing arm having a wheel mount for a wheel of said wheeled conveyance and said swing arm having its pivot point between said one end and said other side of said swing arm.

13. The golf buggy of claim 12, wherein said further part of said wheeled conveyance is above said one end of said swing arm.

14. The golf buggy of claim 12, wherein said extensible biasing means is a spring.

15. The golf buggy of claim 14, wherein said spring is a coil spring.

16. The golf buggy of claim 12, wherein said wheel mount is a sleeve for an axle of said wheel.

17. The golf buggy of claim 12, wherein said further part of said wheeled conveyance includes an arm member.

18. The golf buggy of claim 16, wherein said sleeve is at the other end of said swing arm.

19. The golf buggy of claim 16, wherein said sleeve is between said pivot point and the other end of said swing arm.

20. The golf buggy of claim 19, wherein a further sleeve is provided at the other end of said swing arm, said further sleeve configured to receive a lock means which can interfere with said wheel to limit rotation of said wheel.

21. The golf buggy of claim 20, wherein said lock means has a first position within said further sleeve where said lock means interferes with said wheel to rotation of said wheel and a second position where the lock means is free of said wheel to allow rotation thereof.

22. The golf buggy of claim 12, wherein a stop member is provided on said further part of 2 wheeled conveyance to limit downward movement of said wheel.
